(19) United States
(12) Patent Application Publication
(10) Pub. No.: US 2017/0329553 A1
(43) Pub. Date: Nov. 16, 2017

(54) STORAGE CONTROL DEVICE, STORAGE SYSTEM, AND COMPUTER-READABLE RECORDING MEDIUM

(71) Applicant: FUJITSU LIMITED, Kawasaki-shi (JP)

(72) Inventors: Akira Hori, Nissin (JP); Tomoaki Abe, Nagoya (JP)

(73) Assignee: FUJITSU LIMITED, Kawasaki-shi (JP)

(21) Appl. No.: 15/486,593

(22) Filed: Apr. 13, 2017

(30) Foreign Application Priority Data
May 10, 2016 (JP) 2016-094934

(51) Int. Cl. G06F 3/06

(52) U.S. Cl. CPC G06F 3/0647; G06F 3/0685; G06F 3/0608; G06F 3/0611

(57) ABSTRACT

A short-term tier control unit causes a storage device to execute first relocation, based on an access frequency to each of a plurality of storages with different performances provided in the storage device during a first period, of data stored in each of the storages to each of the storages and to return the data from the first relocation to an original location state. A long-term tier control unit determines a second relocation state of the data to each of the storages based on the access frequency to each of the storages during a second period that is longer than the first period, causes the storage device to execute second relocation, based on the second relocation state, of data on which the first relocation is not performed, and changes the original location state of the data on which the first relocation is performed to the second relocation state.

### CROSS-REFERENCE TO RELATED APPLICATION

This application is based upon and claims the benefit of priority of the prior Japanese Patent Application No. 2016-094934, filed on May 10, 2016, the entire contents of which are incorporated herein by reference.

### FIELD

The embodiments discussed herein are related to a storage control device, a storage system, and a storage device control program.

### BACKGROUND

In recent years, the visualization of an open system and a server has been widespread, and the management of the system has been complicated. Therefore, introduction of storage systems becomes common from the viewpoints of ease of system management and flexible response to rapidly increasing data capacity and the like. Furthermore, the amount of data handled by computers is steadily increasing. Accordingly, the storage capacity of the storage device as a storage used by a computer is also increasing.

Some storage media mounted on storage devices have various performances. In general, a storage medium with high performance such as a solid state drive (SSD) disk and a serial attached SCSI (small computer system interface) (SAS) disk is expensive and it is difficult to secure a large amount of capacity. On the other hand, a storage medium with low performance such as a nearline disk is inexpensive and it is easy to secure a large amount of capacity.

Therefore, in order to respond to an increase in storage capacity and to achieve cost reduction, storage media with different performances are increasingly located in a storage device in consideration of the balance between the storage capacity and the cost. The storage device in which storage media with different performances are installed is called “hierarchical storage device”. In this case, a group of storage media with different performances corresponds to “Tier”.

An optimal file location for the storage media with different performances and a transparent access to files are desired for the hierarchical storage device. In order to achieve these features, the hierarchical storage device is configured to perform hierarchical processing such that data with high access frequency to a file is allocated to a higher-speed storage medium and a file with low access frequency is allocated to a lower-speed storage medium.

As a technology for automatically performing the hierarchical processing based on the number of accesses to disks or the like and changing tiers, there is a technology called storage automatic hierarchical control (AST: Automated Storage Tiering). The storage automatic hierarchical control dynamically locates data not only in storage allocation but also during operation by automatically locating and relocating files to the storage media based on policy for the storage device. This makes it possible to cause the file location state to follow changes in the performance situation during business operation. By dynamically implementing the location design excluding preliminary performance estimation, the work load of the operation manager and the storage administrator can be reduced.

Specifically, the storage automatic hierarchical control monitors access performance of a volume present in each tier called “pool” in which the storage media with different performance characteristics are tiered, and relocates the data between pools according to the set policy. In this manner, the storage automatic hierarchical control makes the storage system demonstrate optimal performance to match the cost by locating the data with high access frequency in the high-performance SSD and locating the data with low access frequency in the inexpensive nearline disk.

Furthermore, in the storage automatic hierarchical control, although data with high access frequency is normally located in the SSD for a certain period of time to increase the speed, control is also performed, in each case, to capture an area where IO (Input Output) concentration occurs within a short period of time and move the IO concentrated area to the SSD. This control is particularly called On The Fly-Automated Storage Tiering (OTF-AST). The OTF-AST monitors the IO load at one-minute intervals and detects the occurrence of a sudden IO load. The area where the sudden IO load occurs is relocated to the SSD by the OTF-AST. Moreover, when it is determined whether the IO load of the area relocated to the SSD is in a continuous state, and when the concentration of the IO load is relaxed, the OTF-AST relocates the area to the tier to which the area belongs before the area is relocated to the SSD. Based on a period from monitoring of the performance to evaluation and relocation set as one cycle, the OTF-AST repeats the cycle at one-minute intervals.

Hereinafter, the technology for achieving a high speed by locating the data with high access frequency in the SSD for a give period of time is called “long-term tier control”, and the control of capturing, in each case, the area where the IO concentration occurs within a short period of time and moving the IO concentrated area to the SSD is called “short-term tier control”. The long-term tier control is suitable for hierarchical control due to fluctuation in access frequency to files with relatively long span of several hours or several days. On the other hand, the short-term tier control is suitable for hierarchical control due to fluctuation in access frequency to files within a short period of time. Therefore, by allowing the long-term tier control and the short-term tier control to coexist, the performance of the storage device can be improved more than the case where each control is used as a single unit.

For example, when only the short-term tier control is used to perform hierarchical control, relocation of files frequently occurs when the high load state and load release are alternately looped, and the performance of the storage device decreases. Therefore, by applying the long-term tier control, it is possible to prevent frequent relocation of files from occurring when the high load state and load release are alternately looped and reduce performance degradation of the storage device.

As a technology for considering long cycle and short cycle load, there is a conventional technology for determining a basic location based on the long cycle and executing inter-tier data relocation considering the short cycle load in combination with the basic location. Furthermore, there is a conventional technology of allocating tiers from a value calculated based on a load index value defined in respective terms of long cycle and short cycle. Moreover, as a technology of hierarchical control, there is a conventional technology for determining a tier as a movement destination according to the type of task and the operation state.
Patent Literature 1: International Publication Pamphlet No. WO 2014/174653
Patent Literature 2: International Publication Pamphlet No. WO 2013/046331
Patent Literature 3: Japanese Laid-open Patent Publication No. 2014-179121

However, when the long-term tier control and the short-term tier control are caused to coexist, there is a possibility that files are not placed in appropriate tiers due to mutual influence. For example, a case is considered in which a high IO load occurs in a short period of time immediately before the end of the evaluation period of the long-term tier control and then the high IO load continues. The case will be explained herein using a three-tier structure in which there are three types of storage media such as SSD, nearline, and online. In this case, the file is moved to the SSD by the short-term tier control right after the end of the evaluation period. However, when the evaluation by the long-term tier control is ended after the file movement to the SSD by the short-term tier control and it is determined that the tier of the file is a nearline disk, the file is moved to the nearline disk even though the IO load is not low. In this way, it is conceivable that a file in which the IO load becomes suddenly high is located in a medium-speed storage medium or in a low-speed storage medium. In this case, because the file is not located in the appropriate tier, the performance of the storage device may be degraded.

Even if using the conventional technology for combining the location determined based on the long cycle with the location considering short cycle load, it is difficult to reduce inappropriate location of files due to mutual influence, and the performance of the storage device may be degraded. Moreover, even if using the conventional technology in which load index values defined in respective terms of the long cycle and the short cycle are used, it is difficult to respond to unexpected IO load, and the performance of the storage device may be degraded. Furthermore, even if using the conventional technology for determining a tier as a movement destination according to the type of task and the operation state, the long cycle load and the short cycle load are not considered, and therefore it is difficult to locate files considering the long cycle load and the short cycle load, so that the performance of the storage device may be degraded.

### SUMMARY

According to an aspect of an embodiment, a storage control device includes: a processor configured to: cause a storage device to execute first relocation, based on an access frequency to each of a plurality of storages with different performances provided in the storage device during a first period, of data stored in each of the storages to each of the storages and to return the data from the first relocation to an original location state; determine a second relocation state of the data to each of the storages based on the access frequency to each of the storages during a second period that is longer than the first period; cause the storage device to execute second relocation, based on the second relocation state, of data on which the first relocation is not performed; and change the original location state of the data on which the first relocation is performed to the second relocation state.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of a storage system according to a first embodiment;

FIG. 2 is a diagram for explaining transition of each piece of information in automatic hierarchical control when a return tier by the storage system according to the first embodiment matches the long-term evaluation;

FIG. 3 is a diagram for explaining transition of each piece of information in the automatic hierarchical control when the return tier by the storage system according to the first embodiment is different from the long-term evaluation;

FIG. 4 is a flowchart of the automatic hierarchical control by an operation management server according to the first embodiment;

FIG. 5 is a block diagram of a storage system according to a second embodiment;

FIG. 6 is a diagram for explaining transition of each piece of information in the automatic hierarchical control by the storage system according to the second embodiment;

FIG. 7 is a flowchart of the automatic hierarchical control by an operation management server according to the second embodiment;

FIG. 8 is a block diagram of a storage system according to a third embodiment;

FIG. 9 is a flowchart of the automatic hierarchical control by an operation management server according to the third embodiment;

FIG. 10 is a hardware configuration diagram of the operation management server; and

FIG. 11 is a hardware configuration diagram of the storage device.

### DESCRIPTION OF EMBODIMENTS

Preferred embodiments of the present invention will be explained with reference to accompanying drawings. The storage control device, the storage system, and the storage device control program disclosed in the present application are not limited by the following embodiments.

### [a] First Embodiment

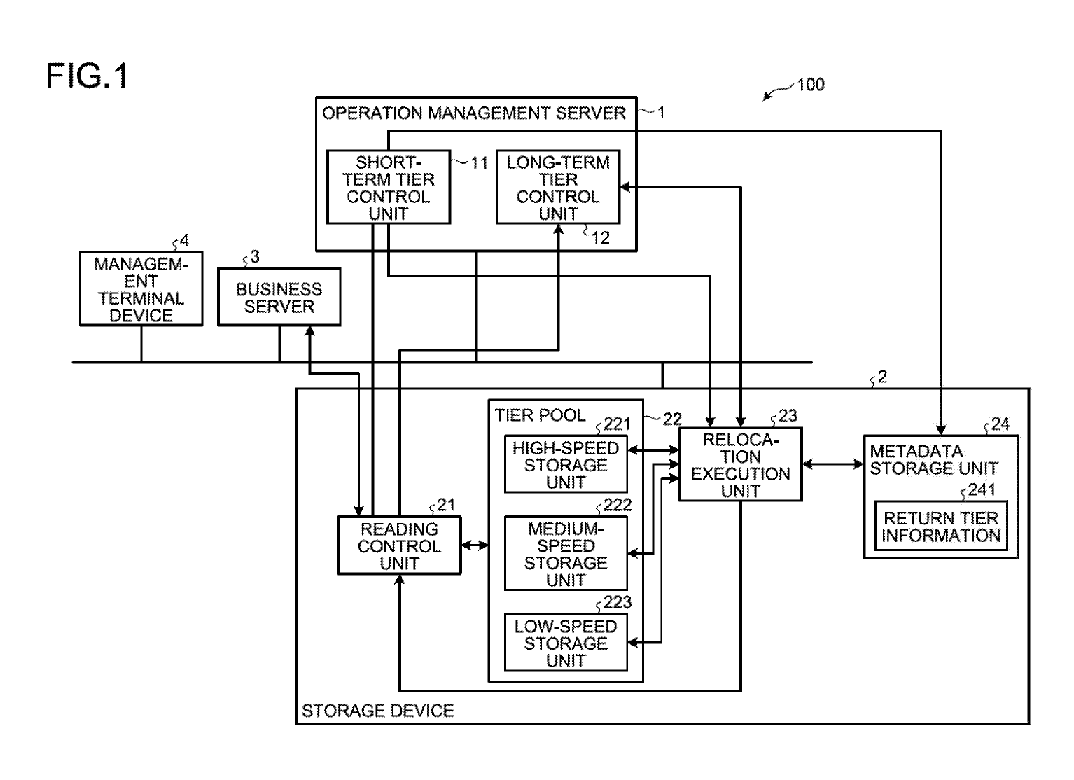

FIG. 1 is a block diagram of a storage system according to a first embodiment. A storage system 100 includes an operation management server 1, a storage device 2, a business server 3, and a management terminal device 4.

The management terminal device 4 is an terminal that instructs the operation management server 1 to control the storage device 2. The management terminal device 4 provides a graphical user interface (GUI) for controlling the storage device 2 to an operator. The management terminal device 4 transmits an instruction to start automatic hierarchical control and an instruction to stop automatic hierarchical control, which are input using the GUI, to the operation management server 1.

The business server 3 is a server that provides business services in cooperation with the storage device 2. The business server 3 transmits data write and read instructions and the like to the storage device 2. The business server 3 receives responses to the data write and read instructions from the storage device 2.

The storage device 2 includes a reading control unit 21, a Tier pool 22, a relocation execution unit 23, and a metadata storage unit 24.

The Tier pool 22 includes a high-speed storage unit 221, a medium-speed storage unit 222, and a low-speed storage unit 223. The Tier pool 22 is sometimes called Flexible Tier pool (FTRP). The high-speed storage unit 221 includes SSD. The medium-speed storage unit 222 includes a nearline disk drive. The low-speed storage unit 223 includes an online disk drive. In the present embodiment, although the tier is formed by using the SSD, the nearline disk, and the online disk, any disk may be used if disks are different in speed and cost. In the present embodiment, the Tier pool is divided into three tiers such as the high-speed storage unit 221, the medium-speed storage unit 222, and the low-speed storage unit 223, however, the number of tiers is not limited to three tiers. The tier is sometimes called a sub-pool or a Flexible Tier Sub Pool (FISP). Moreover, each tier has an allocation unit area in which a virtual volume allocated to a server such as the business server 3 is formed. The allocation unit area is called a Flexible Tier Pool Element (FTRPE).

A virtual volume allocated to the business server 3 is present in the Tier pool 22 formed with the high-speed storage unit 221, the medium-speed storage unit 222, and the low-speed storage unit 223. The virtual volume is allocated as an area used by each area in the respective allocation unit areas of the high-speed storage unit 221, the medium-speed storage unit 222, and the low-speed storage unit 223. Thus, the virtual volumes are formed as areas over the high-speed storage unit 221, the medium-speed storage unit 222, and the low-speed storage unit 223. The virtual volume may be called a Flexible Tier Volume (FTV). Other virtual volume allocated to a server other than the business server 3 may be present in the Tier pool 22.

Each volume included in the high-speed storage unit 221, the medium-speed storage unit 222, and the low-speed storage unit 223 is relocated by the relocation execution unit 23. Specifically, an allocation unit area with high access frequency is moved to a higher-speed tier. The high-speed storage unit 221, the medium-speed storage unit 222, and the low-speed storage unit 223 correspond to one example of “storage”.

The reading control unit 21 receives a data read instruction from the business server 3. The reading control unit 21 identifies a volume in which the data specified by the read instruction is present. Subsequently, the reading control unit 21 accesses the identified volume to read the data. Specifically, the reading control unit 21 previously receives information for each tier as a location destination of each data from the relocation execution unit 23. Then, the reading control unit 21 identifies a tier in which the data specified by the read instruction is stored, and reads the specified data from the identified tier in the volume. The reading control unit 21 then transmits the read data to the business server 3.

The reading control unit 21 receives a data write instruction from the business server 3. When the write instruction is data update, the reading control unit 21 identifies a volume in which the data specified by the write instruction is present. Subsequently, the reading control unit 21 accesses the identified volume to overwrite the data. In this case also, the reading control unit 21 identifies a tier from the information for each tier as a storage destination of each data previously notified from the relocation execution unit 23, and overwrites the data in the identified tier in the volume. Thereafter, the reading control unit 21 transmits a response indicating the writing completion to the business server 3.

When the write instruction is writing of new data, the reading control unit 21 identifies a volume specified by the write instruction. The reading control unit 21 then writes the data to a predetermined new writing tier in the identified volume. Here, the reading control unit 21 stores the new writing tier in, for example, the medium-speed storage unit 222. Thereafter, the reading control unit 21 transmits a response indicating the writing completion to the business server 3.

Furthermore, the reading control unit 21 transmits data write and read information together with the information of the allocation unit area where the data is stored to a short-term tier control unit 11 and a long-term tier control unit 12 of the operation management server 1 explained later. Hereinafter, the information of data write and data read to and from each allocation unit area is called “access information” to the allocation unit area.

The metadata storage unit 24 is a storage such as a cache. The metadata storage unit 24 stores return tier information 241 indicating a tier after the return of the allocation unit area of which relocation to the high-speed storage unit 221 is performed based on short-term evaluation. In other words, the allocation unit area moved to the high-speed storage unit 221 based on the short-term evaluation is returned to the tier indicated in the return tier information 241 when the IO load is reduced. The tier indicated by the return tier information 241 corresponds to one example of “original location state”.

For example, when the relocation is performed based on the short-term evaluation for a specific allocation unit area, the tier before the relocation of the specific allocation unit area is stored in the metadata storage unit 24 as the return tier information 241 of the specific allocation unit area. When relocation to a specific allocation unit area by long-term evaluation is determined in a state in which the relocation to the high-speed storage unit 221 is performed based on the short-term evaluation, the return tier information 241 of the specific allocation unit area is changed to the tier as the relocation destination determined based on the long-term evaluation.

The relocation execution unit 23 receives an instruction of relocation from the short-term tier control unit 11 when the relocation is performed based on the short-term evaluation. The relocation execution unit 23 then performs relocation from the medium-speed storage unit 222 or the low-speed storage unit 223 to the high-speed storage unit 221 for each allocation unit area according to the instruction of relocation. Specifically, the relocation execution unit 23 copies the specified allocation unit area to the high-speed storage unit 221. The relocation execution unit 23 notifies the reading control unit 21 of the position where the data of relocation destination is stored. Moreover, the relocation execution unit 23 associates the information of the tier where data before the relocation is stored with the data identification information and registers the information as the return tier information 241 in the metadata storage unit 24.

Thereafter, when the relocated allocation unit area is returned, the relocation execution unit 23 receives an instruction of relocation to the original tier from the short-term tier control unit 11. In this case, the relocation execution unit 23 acquires the return tier information 241 for the allocation unit area to be returned from the metadata storage unit 24. The relocation execution unit 23 then determines whether the tier indicated by the return tier information 241 for the allocation unit area to be returned matches the tier before the relocation of the allocation unit area to be returned. When the tier indicated by the return tier information 241 matches the tier before the relocation, the relocation execution unit 23 determines whether writing is performed to the allocation unit area to be returned during which it is located in the high-speed storage unit 221.

When the writing is not performed, the relocation execution unit 23 deletes the allocation unit area to be returned from the high-speed storage unit 221. The relocation execution unit 23 notifies the reading control unit 21 of the tier indicated by the return tier information 241 for the allocation unit area to be returned and of the identification information for the data. On the other hand, when the writing is performed, the relocation execution unit 23 copies the allocation unit area to be returned to the tier indicated by the return tier information 241. Thereafter, the relocation execution unit 23 deletes the allocation unit area to be returned from the high-speed storage unit 221. The relocation execution unit 23 notifies the reading control unit 21 of the tier indicated by the return tier information 241 for the allocation unit area to be returned and of the identification information for the data.

When the return tier information 241 for the allocation unit area to be returned does not match the tier before the relocation of the allocation unit area to be returned, the relocation execution unit 23 copies the allocation unit area to be returned to the tier indicated by the return tier information 241. Thereafter, the relocation execution unit 23 deletes the allocation unit area to be returned from the high-speed storage unit 221. The relocation execution unit 23 then notifies the reading control unit 21 of the tier indicated by the return tier information 241 for the allocation unit area to be returned and of the identification information for the data.

When the relocation is determined based on the long-term evaluation, the relocation execution unit 23 receives an instruction of the relocation from the long-term tier control unit 12 of the operation management server 1. In this case, the relocation execution unit 23 determines whether the return tier information 241 for the allocation unit area of which relocation is specified is present in the metadata storage unit 24. When the return tier information 241 for the allocation unit area of which relocation is specified is not present in the metadata storage unit 24, the relocation execution unit 23 moves the allocation unit area to the low-speed storage unit 223, the medium-speed storage unit 222, or to the high-speed storage unit 221 for each allocation unit area according to the instruction of the relocation. For example, when receiving the instruction of the relocation of the allocation unit area stored in the medium-speed storage unit 222 to the high-speed storage unit 221, the relocation execution unit 23 extracts the specified allocation unit area from the medium-speed storage unit 222 and moves it to the high-speed storage unit 221. The relocation execution unit 23 then notifies the reading control unit 21 of the position where the data for the relocation destination is stored.

On the other hand, when the return tier information 241 for the allocation unit area of which relocation is specified is present in the metadata storage unit 24, the relocation execution unit 23 acquires the return tier information 241 for the allocation unit area of which relocation is specified from the metadata storage unit 24. Subsequently, the relocation execution unit 23 compares the tier indicated by the acquired return tier information 241 with the tier specified as the relocation destination based on the long-term evaluation. When the tier indicated by the acquired return tier information 241 is different from the tier specified as the relocation destination based on the long-term evaluation, the relocation execution unit 23 changes the return tier information 241 stored in the metadata storage unit 24 to the tier as the relocation destination based on the long-term evaluation.

In the present embodiment, the comparison between the tier indicated by the return tier information 241 and tier as the relocation destination based on the long-term evaluation is performed in the storage device 2, however, the embodiment is not limited thereto. For example, the long-term tier control unit 12 of the operation management server 1 may perform the comparison.

The short-term tier control unit 11 receives access information to each allocation unit area from the reading control unit 21. The short-term tier control unit 11 calculates the number of accesses in a predetermined period of time for each allocation unit area from the received access information. Although the present embodiment will be explained using a case where the predetermined period of time is one minute, it is preferable that the period of time is determined according to the frequency with which relocation is determined based on the short-term evaluation in the operation of the storage device 2.

The short-term tier control unit 11 has a short-term high load threshold and a short-term low load threshold in advance. The short-term high load threshold and the short-term low load threshold can take appropriate values if the short-term high load threshold is the short-term low load threshold or more.

The short-term tier control unit 11 determines whether the number of accesses for one minute is the short-term high load threshold or more for each allocation unit area. The number of accesses can be called an IO load. When there is an allocation unit area to which the number of accesses for one minute is the short-term high load threshold or more, the short-term tier control unit 11 instructs the relocation execution unit 23 to perform relocation of the allocation unit area to the high-speed storage unit 221. However, when the allocation unit area to which the number of accesses is short-term high load threshold or more is already located in the high-speed storage unit 221, the short-term tier control unit 11 does not perform relocation of the allocation unit area. The relocation based on the short-term evaluation corresponds to one example of “first relocation”. Moreover, the short-term tier control unit 11 registers the tier before execution of the relocation of the allocation unit area, whose relocation is executed based on the short-term evaluation, in the return tier information 241 provided in the metadata storage unit 24.

Thereafter, when the number of accesses for one minute of the allocation unit area which is relocated to the high-speed storage unit 221 is below a predetermined value, the short-term tier control unit 11 instructs the relocation execution unit 23 to perform relocation of the allocation unit area to its original tier. Thereafter, the short-term tier control unit 11 deletes the return tier information 241 for the allocation unit area, of which tier is returned, stored in the metadata storage unit 24. In other words, it can be said that the allocation unit area of which return tier information 241 is stored in the metadata storage unit 24 is relocated to the high-speed storage unit 221 based on the short-term evaluation. The short-term tier control unit 11 corresponds to one example of “first relocation unit”.

The long-term tier control unit 12 receives the access information to each allocation unit area from the reading control unit 21. The long-term tier control unit 12 calculates the number of accesses in a predetermined period of time for each allocation unit area from the received access information. Although the present embodiment will be explained using a case where the predetermined period of time is a minimum of 15 minutes, the period of time is preferably determined according to the frequency with which relocation is determined based on the long-term evaluation in the operation of the storage device 2. The number of accesses in the predetermined period of time used by the short-term tier control unit 11 and the long-term tier control unit 12 corresponds to one example of “access frequency”.

The long-term tier control unit 12 has a long-term high load threshold and a long-term low load threshold in advance. When the number of accesses to a certain allocation unit area for 15 minutes is the long-term high load threshold or more, the long-term tier control unit 12 determines that the allocation unit area is located in the high-speed storage unit 221. When the number of accesses to a certain allocation unit area for 15 minutes is less than the long-term high load threshold and the long-term low load threshold or more, the long-term tier control unit 12 determines that the allocation unit area is located in the medium-speed storage unit 222. Moreover, when the number of accesses to a certain allocation unit area for 15 minutes is lees than the long-term low load threshold, the long-term tier control unit 12 determines that the allocation unit area is located in the low-speed storage unit 223. The relocation based on the long-term evaluation corresponds to one example of “second relocation”. Thereafter, when the tier in which it is located is different from the current tier, the long-term tier control unit 12 instructs the relocation execution unit 23 to relocate the allocation unit area to the determined tier. The long-term tier control unit 12 corresponds to one example of “second relocation unit”.

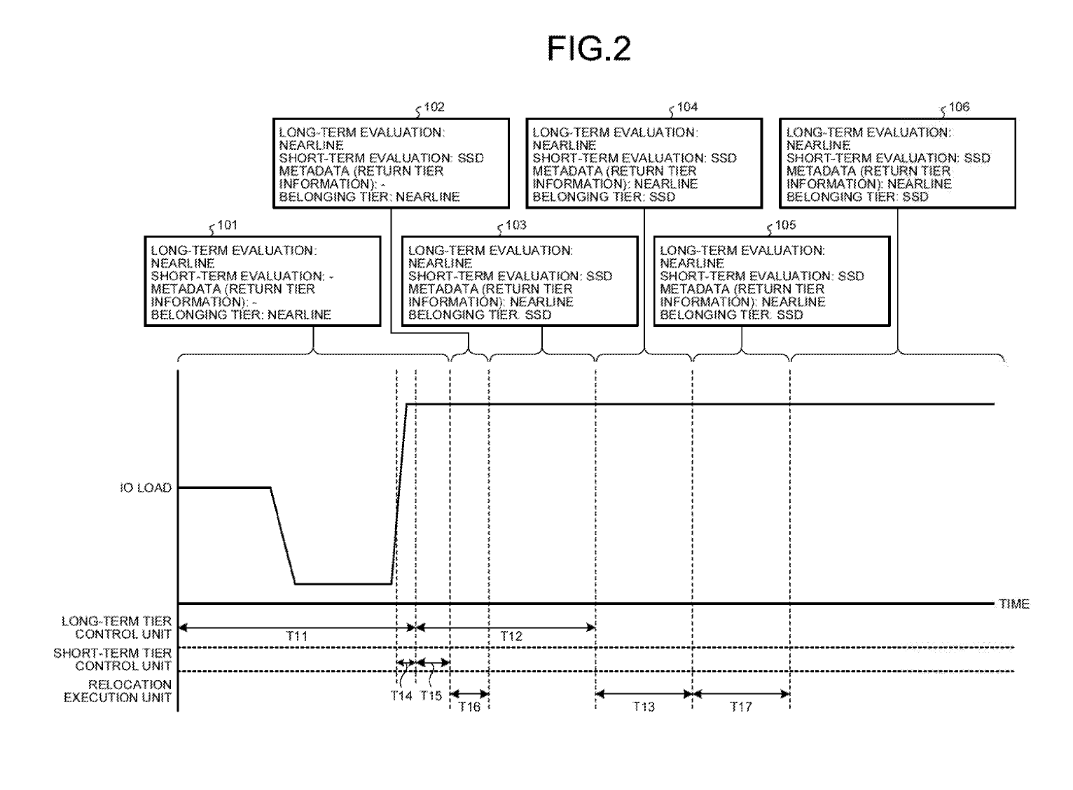

Transition of each piece of information in the automatic hierarchical control when the return tier by the storage system 100 and the long-term evaluation match each other will be explained next with reference to FIG. 2. FIG. 2 is a diagram for explaining transition of each piece of information in automatic hierarchical control when the return tier by the storage system according to the first embodiment matches the long-term evaluation. The vertical axis in the graph of FIG. 2 represents IO load, and the horizontal axis represents time. It is assumed herein that the high-speed storage unit 221 is set as an SSD and the medium-speed storage unit 222 is set as a nearline disk.

Furthermore, a state in which the specific allocation unit area is stored in the nearline disk through the relocation based on the long-term evaluation will be explained as an initial state. Hereinafter, the tier as the relocation destination based on the long-term evaluation is called “tier for long-term evaluation”, and the tier as the relocation destination based on the short-term evaluation is called “tier for short-term evaluation”. Both are simply represented as long-term evaluation and short-term evaluation in FIG. 2.

In term T11, the long-term tier control unit 12 acquires the number of accesses to the allocation unit area and collects information for the long-term evaluation. In this case, because the specific allocation unit area is in the initial state, the tier for long-term evaluation is the nearline disk and a belonging tier is also the nearline, as illustrated in data 101.

Here, the IO load rapidly increases immediately before the term T11 ends. In term T14 of this timing, the short-term tier control unit 11 acquires the number of accesses to the allocation unit area and collects information for the short-term evaluation.

After the information collection for the long-term evaluation is ended, the long-term tier control unit 12 performs the long-term evaluation in term T12. Moreover, after the information collection for the short-term evaluation is ended, the short-term tier control unit 11 performs the short-term evaluation in term T15. During this period also, the initial state continues, and, as illustrated in data 101, the tier for long-term evaluation is the nearline disk and the belonging tier is also the nearline.

When the term T15 is ended, the short-term tier control unit 11 determines the tier for short-term evaluation of the specific allocation unit area as SSD which is the high-speed storage unit 221. The short-term tier control unit 11 then instructs the relocation execution unit 23 to relocate the specific allocation unit area to the SSD. Thereafter, in term T16, the relocation execution unit 23 performs relocation of the specific allocation unit area to the SSD. During this period, the tier for short-term evaluation becomes SSD as illustrated in data 102.

Thereafter, when the relocation execution unit 23 ends the relocation, the specific allocation unit area belongs to the SSD, as illustrated in data 103. Thereafter, the term T12 during which the long-term evaluation is performed by the long-term tier control unit 12 is ended. In this case, the IO load sharply increases just before the long-term evaluation, and, as a whole, the IO load is not so large. Therefore, the long-term tier control unit 12 determines the tier for long-term evaluation as the nearline disk. The long-term tier control unit 12 then instructs the relocation execution unit 23 to relocate the allocation unit area to the nearline disk. During this period, the belonging tier of the specific allocation unit area becomes SSD.

Thereafter, in term T13, the relocation execution unit 23 determines whether the return tier information 241 stored in the metadata storage unit 24 and the tier for long-term evaluation match each other. In this case, as illustrated in data 104, both the return tier information 241 stored in the metadata storage unit 24 and the tier for long-term evaluation are the nearline disk, which match each other. Therefore, the relocation execution unit 23 keeps the return tier information 241 stored in the metadata storage unit 24 as it is. The relocation execution unit 23 performs relocation of the specific allocation unit area according to the instruction. In this case, however, because the specific allocation unit area is already in the nearline disk, the relocation execution unit 23 does not perform tier movement of the specific allocation unit area. In such a case, as illustrated in data 105, the same state as that of the data 104 continues.

When the relocation execution unit 23 ends the relocation of the data, in term T17, the long-term tier control unit 12 acquires the number of accesses to the allocation unit area and collects information for the long-term evaluation. In this case also, as illustrated in data 106, the same state as that of the data 105 continues. In other words, when the short-term tier control unit 11 determines the return of the specific allocation unit area, the relocation execution unit 23 moves the specific allocation unit area to the nearline disk which is the tier before the relocation based on the short-term evaluation. In other words, the specific allocation unit area returns to the tier before the relocation based on the short-term evaluation.

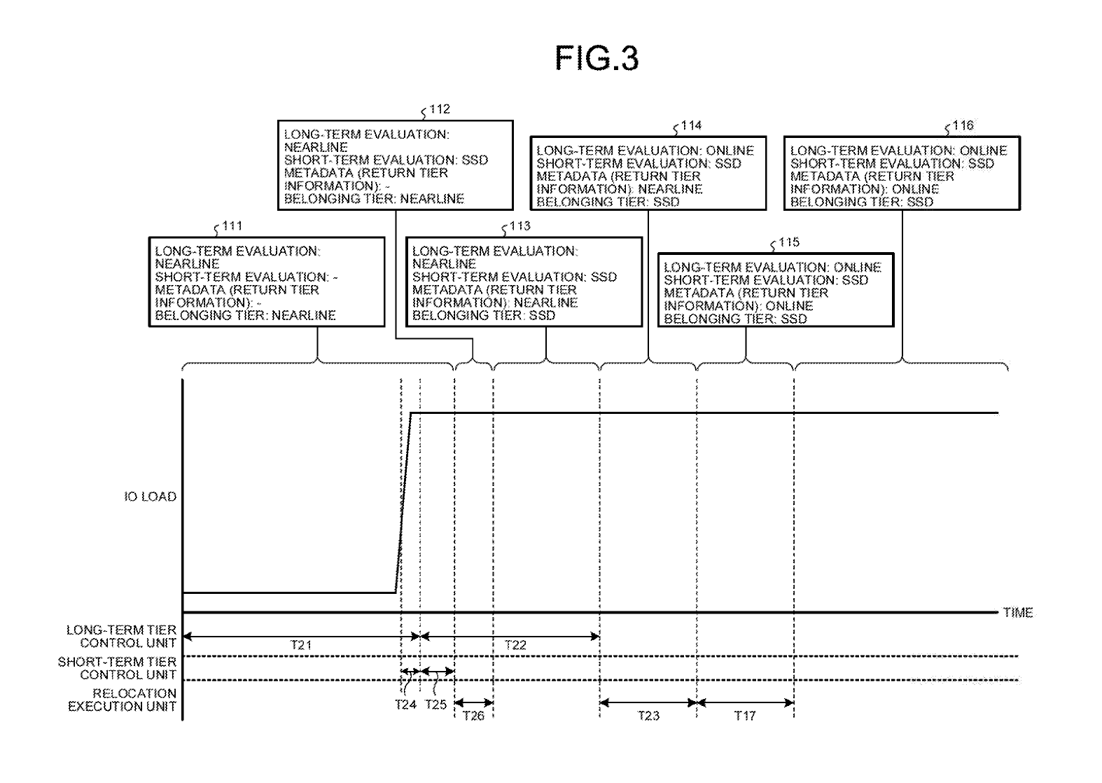

Transition of each piece of information in automatic hierarchical control when the return tier by the storage system 100 is different from the long-term evaluation will be explained next with reference to FIG. 3. FIG. 3 is a diagram for explaining transition of each piece of information in the automatic hierarchical control when the return tier by the storage system according to the first embodiment is different from the long-term evaluation. The vertical axis in the graph of FIG. 3 represents IO load, and the horizontal axis represents time. Furthermore, a state in which the specific allocation unit area is stored in the nearline disk through the relocation based on the long-term evaluation will be explained as an initial state. The low-speed storage unit 223 will be explained herein as an online disk.

In term T21, the long-term tier control unit 12 acquires the number of accesses to the allocation unit area and collects information for the long-term evaluation. In this case, because the specific allocation unit area is in the initial state, the tier for long-term evaluation is the nearline disk and the belonging tier is also the nearline, as illustrated in data 111.

Here, the IO load rapidly increases immediately before the term T21 ends. In term T24 of this timing, the short-term tier control unit 11 acquires the number of accesses to the allocation unit area and collects information for the short-term evaluation.

After the information collection for the long-term evaluation is ended, the long-term tier control unit 12 performs the long-term evaluation in term T22. Moreover, after the information collection for the short-term evaluation is ended, the short-term tier control unit 11 performs the short-term evaluation in term T25. During this period also, the initial state continues, and, as illustrated in data 111, the tier for long-term evaluation is the nearline disk and the belonging tier is also the nearline.

When the term T25 ends, the short-term tier control unit 11 determines the tier for short-term evaluation of the specific allocation unit area as SSD which is the high-speed storage unit 221. The short-term tier control unit 11 then instructs the relocation execution unit 23 to relocate the specific allocation unit area to the SSD. Thereafter, in term T26, the relocation execution unit 23 performs relocation of the specific allocation unit area to the SSD. During this period, the tier for short-term evaluation becomes SSD as illustrated in data 112.

Thereafter, when the relocation execution unit 23 ends the relocation, the specific allocation unit area belongs to the SSD as illustrated in data 113. Thereafter, the term T22 of the long-term evaluation performed by the long-term tier control unit 12 ends. In this case, the IO load sharply increases just before the end of the long-term evaluation, and before the increase, low IO load continues. Therefore, the long-term tier control unit 12 determines the tier for long-term evaluation as an online disk and instructs the relocation execution unit 23 to relocate the allocation unit area to the online disk. During this period, the belonging tier of the specific allocation unit area becomes SSD.

Thereafter, in term T23, the relocation execution unit 23 determines whether the return tier information 241 stored in the metadata storage unit 24 matches the tier for long-term evaluation. In this case, as illustrated in data 114, the return tier information 241 stored in the metadata storage unit 24 is the nearline disk and the tier for long-term evaluation is the online disk, which do not match each other. Therefore, the relocation execution unit 23 changes the return tier information 241 stored in the metadata storage unit 24 to the online disk. In this case, the relocation execution unit 23 does not perform tier movement of the specific allocation unit area. In such a case, as illustrated in data 115, the return tier information 241 is changed from the nearline disk to the online disk.

When the relocation execution unit 23 ends the relocation of the data, in term T17, the long-term tier control unit 12 acquires the number of accesses to the allocation unit area and collects information for the long-term evaluation. In this case, as illustrated in data 116, the same state as that of the data 115 continues. In other words, in such a case, when the short-term tier control unit 11 determines the return of the specific allocation unit area, the relocation execution unit 23 moves the specific allocation unit area to the online disk which is the tier of the relocation determined based on the long-term evaluation after the relocation based on the short-term evaluation. In other words, the specific allocation unit area is moved to the tier of the relocation based on the long-term evaluation.

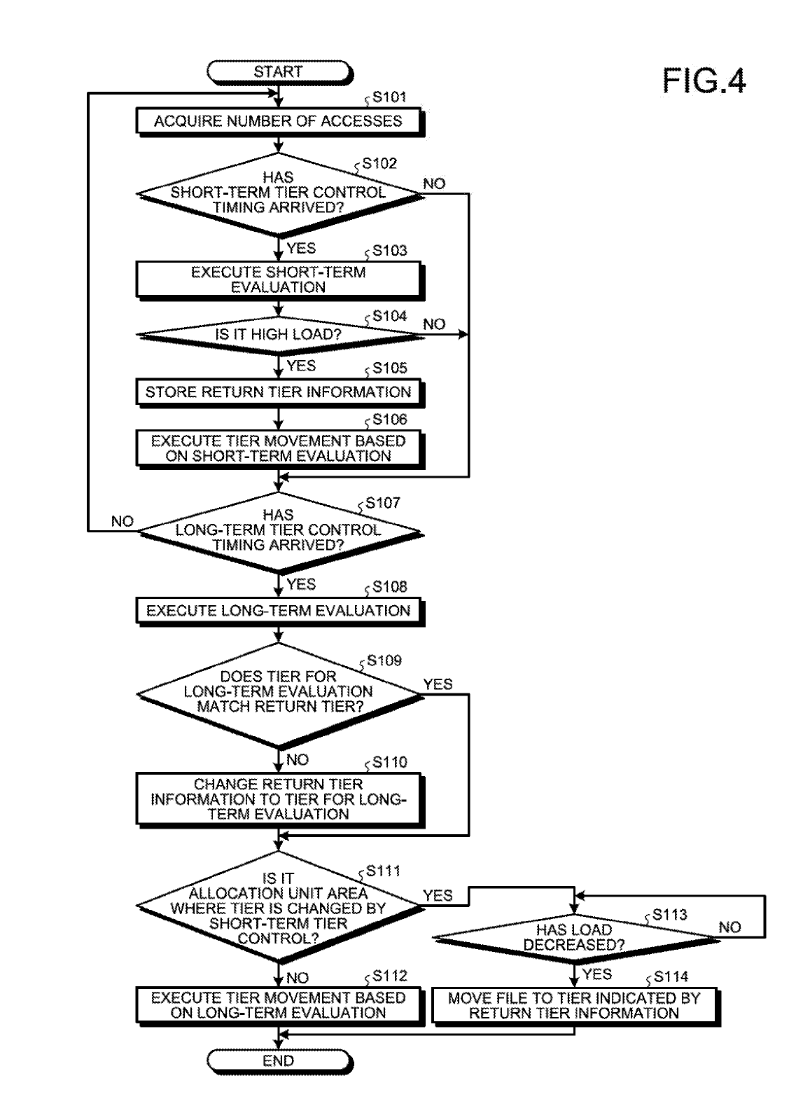

Moreover, a flow of the automatic hierarchical control by the operation management server 1 according to the first embodiment will be explained below with reference to FIG. 4. FIG. 4 is a flowchart of the automatic hierarchical control by the operation management server according to the first embodiment. Herein below, the allocation unit area as a target of the automatic hierarchical control is called “target area”.

The short-term tier control unit 11 and the long-term tier control unit 12 receive the number of accesses to the target area from the reading control unit 21 (Step S101).

Subsequently, the short-term tier control unit 11 determines whether a short-term tier control timing has arrived (Step S102). When a short-term tier control timing has not arrived (No at Step S102), the short-term tier control unit 11 and the long-term tier control unit 12 proceed to Step S107.

On the other hand, when a short-term tier control timing has arrived (Yes at Step S102), the short-term tier control unit 11 executes the short-term evaluation (Step S103). The short-term tier control unit 11 then determines whether the IO load of the target area is a high load such as the short-term high load threshold or more based on the short-term evaluation (Step S104). When the IO load of the target area is not a high load (No at Step S104), the short-term tier control unit 11 and the long-term tier control unit 12 proceed to Step S107.

On the other hand, when the IO load of the target area is a high load (Yes at Step S104), the short-term tier control unit 11 stores the belonging tier of the target area before the relocation as the return tier information 241 of the target area in the metadata storage unit 24 (Step S105).

Subsequently, the short-term tier control unit 11 performs tier movement based on the short-term evaluation (Step S106).

The long-term tier control unit 12 determines whether a long-term tier control timing has arrived (Step S107). When a long-term tier control timing has not arrived (No at Step S102), the short-term tier control unit 11 and the long-term tier control unit 12 return to Step S101.

On the other hand, when a long-term tier control timing has arrived (Yes at Step S107), the long-term tier control unit 12 executes the long-term evaluation (Step S108). The long-term tier control unit 12 determines whether the tier as the relocation destination of the long-term evaluation matches the return tier (Step S109). When the tier as the relocation destination of the long-term evaluation matches the return tier (Yes at Step S109), the long-term tier control unit 12 proceeds to Step S111.

On the other hand, when the tier as the relocation destination of the long-term evaluation does not match the return tier (No at Step S109), the long-term tier control unit 12 changes the return tier information 241 to the tier as the relocation destination of the long-term evaluation (Step S110).

Subsequently, the long-term tier control unit 12 determines whether the target area is the allocation unit area where the tier is changed through the short-term tier control by the short-term tier control unit 11 (Step S111). When the target area is not the allocation unit area where the tier is changed by the short-term tier control (No at Step S111), the long-term tier control unit 12 performs tier movement based on the long-term evaluation (Step S112).

On the other hand, when the target area is the allocation unit area where the tier is changed by the short-term tier control (Yes at Step S111), the short-term tier control unit 11 determines whether the IO load of the target area has decreased below the short-term low load threshold (Step S113). When the IO load of the target area has not decreased below the short-term low load threshold (No at Step S113), the short-term tier control unit 11 waits until the IO load of the target area decreases below the short-term low load threshold.

On the other hand, when the IO load of the target area has decreased below the short-term low load threshold (Yes at Step S113), the short-term tier control unit 11 moves the file to the tier indicated by the return tier information 241 (Step S114).

As explained above, the storage system according to the present embodiment stores the tier before the short-term tier control is performed as the return tier information. When relocation based on the long-term evaluation is determined in a state in which the allocation unit area is moved to the high speed disk by the long-term tier control, the storage system changes the return tier information to the tier as the relocation destination based on the long-term evaluation. Thereafter, when the load of the allocation unit area decreases, the storage system moves the allocation unit area to the tier indicated by the return tier information.

Thus, the storage system according to the present embodiment can prevent the allocation unit area moved to the high speed disk by the short-term tier control from being immediately moved to a medium-speed disk or to a low-speed disk by the long-term tier control. Specifically, it is possible to prevent the allocation unit area from being moved to the low-speed disk or to the medium-speed disk even though the IO load does not decrease in the short term. In other words, it is possible to eliminate competition between OTF-AST which is the short-term tier control and AST which is the long-term tier control. This makes it possible to avoid degradation of the performance of the storage device.

### [b] Second Embodiment

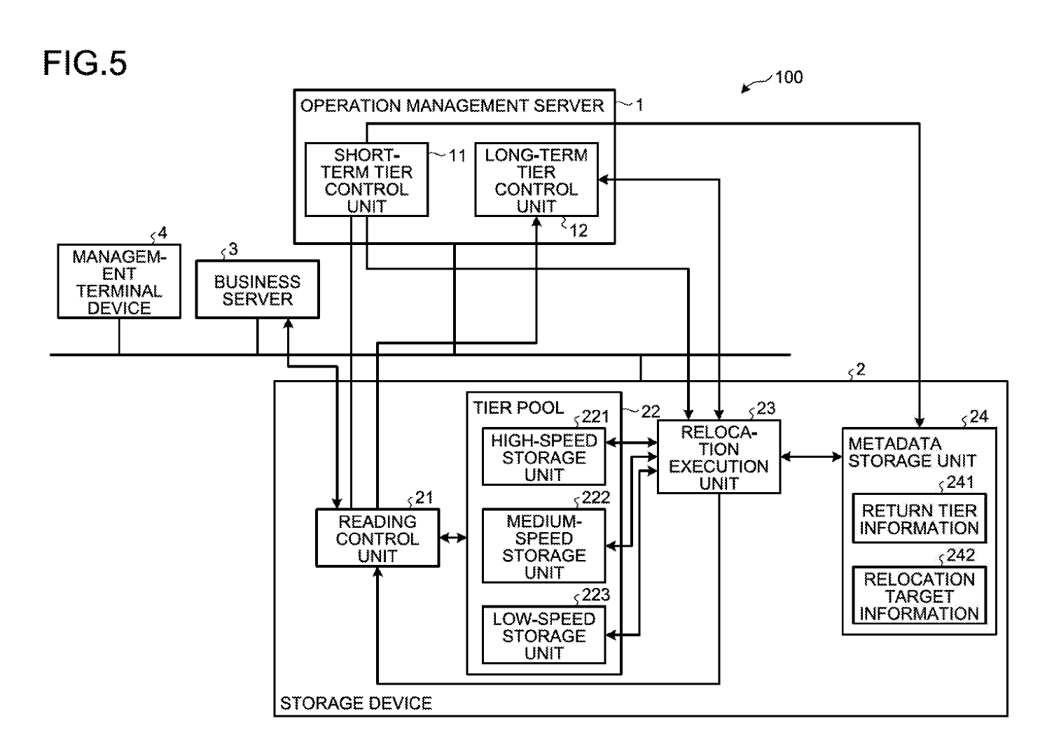

FIG. 5 is a block diagram of a storage system according to a second embodiment. The storage system according to the present embodiment is different from the first embodiment in that the allocation unit area under execution of relocation based on the long-term evaluation is excluded from an evaluation target of the short-term tier control. Therefore, the short-term tier control excluding the allocation unit area under execution of the relocation based on the long-term evaluation will be mainly explained below. Moreover, explanation of the operations of the units similar to these of the first embodiment is omitted.

The storage device 2 according to the present embodiment includes relocation target information 242 in the metadata storage unit 24 when the relocation is performed based on the long-term evaluation by the long-term tier control unit 12. The relocation target information 242 is information indicating an allocation unit area of which relocation is executed based on the long-term evaluation by the long-term tier control unit 12.

The relocation execution unit 23 receives an instruction to execute relocation based on the long-term evaluation from the long-term tier control unit 12. The relocation execution unit 23 then determines whether the relocation based on the short-term evaluation is being executed. When the relocation based on the short-term evaluation is being executed, the relocation execution unit 23 compares the tier indicated by the return tier information 241 stored in the metadata storage unit 24 with the tier as the relocation destination based on the long-term evaluation. When the tier indicated by the return tier information 241 does not match the tier as the relocation destination based on the long-term evaluation, the relocation execution unit 23 changes the return tier information 241 to the tier as the relocation destination based on the long-term evaluation.

Meanwhile, when the relocation based on the short-term evaluation is not executed, the relocation execution unit 23 registers the information for the allocation unit area of which relocation based on the long-term evaluation is performed in the relocation target information 242 of the metadata storage unit 24.

Thereafter, when the relocation based on the long-term evaluation is ended, the relocation execution unit 23 deletes the information of the allocation unit area which is registered in the relocation target information 242 of the metadata storage unit 24 and of which relocation based on the long-term evaluation is performed, and adds the information to a target for the short-term tier control.

The relocation execution unit 23 receives an instruction of relocation based on the short-term evaluation from the short-term tier control unit 11. The relocation execution unit 23 then executes relocation of the allocation unit area based on the short-term evaluation according to the received instruction of relocation.

When a timing of short-term tier control has arrived, the short-term tier control unit 11 acquires the information of the allocation unit area under execution of relocation based on the long-term evaluation from the relocation target information 242 of the metadata storage unit 24. The short-term tier control unit 11 then excludes the allocation unit area under execution of relocation based on the long-term evaluation from the evaluation target, and executes the short-term evaluation. Thereafter, the short-term tier control unit 11 transmits an instruction to execute the relocation based on the short-term evaluation to the relocation execution unit 23.

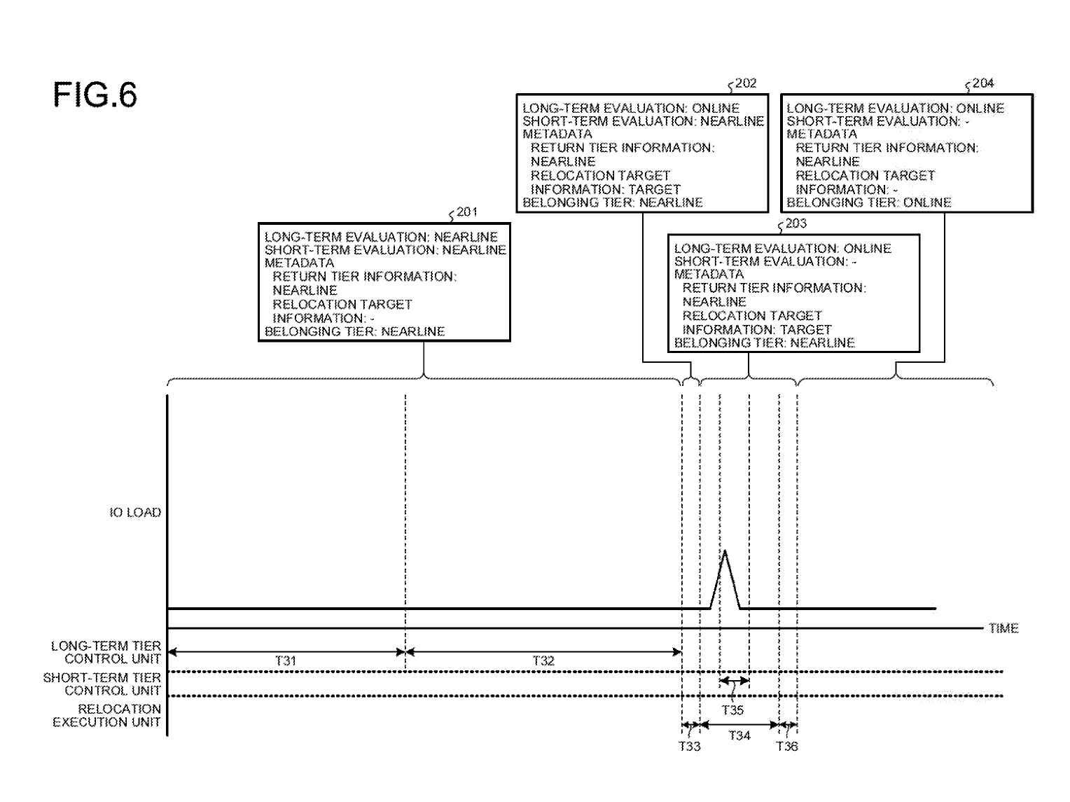

Transition of each piece of information in the automatic hierarchical control by the storage system 100 according to the present embodiment will be explained next with reference to FIG. 6. FIG. 6 is a diagram for explaining transition of each piece of information in the automatic hierarchical control by the storage system according to the second embodiment. For the short-term tier control, explanation is performed by focusing on the control targeting a period during which relocation is performed based on the long-term evaluation. The vertical axis in the graph of FIG. 6 represents IO load, and the horizontal axis represents time. The automatic hierarchical control for the specific allocation unit area will be explained below. The automatic hierarchical control will be explained using a case in which the high-speed storage unit 221 is an SSD, the medium-speed storage unit 222 is a nearline disk, and the low-speed storage unit 223 is an online disk. Moreover, explanation is performed using a case where the state, in which the specific allocation unit area is stored in the nearline disk by relocation based on the long-term evaluation, is the initial state and the allocation unit area is returned to the nearline disk after the relocation to the SSD based on the short-term evaluation.

The long-term tier control unit 12 acquires the IO load for performing long-term tier control in term T31. Thereafter, the long-term tier control unit 12 executes long-term evaluation using the IO load acquired in term T32. During this period, the tier of the long-term evaluation is nearline, and the tier of the short-term evaluation is nearline. The tier indicated by the return tier information 241 is nearline disk. During this period, as illustrated in data 201, the tier of the long-term evaluation is the nearline disk, the tier of the short-term evaluation is the nearline, the return tier is the nearline, and the belonging tier is the nearline.

Subsequently, the long-term tier control unit 12 determines the tier of the long-term evaluation as online, and instructs the relocation execution unit 23 to execute relocation of the specific allocation unit area. The relocation execution unit 23 receives the instruction of relocation from the long-term tier control unit 12. A case where relocation based on the short-term evaluation is not performed will be explained herein. As illustrated in data 202 in term T33, the relocation execution unit 23 registers information indicating that the specific allocation unit area is a target of the relocation based on the long-term evaluation in the relocation target information 242.

Thereafter, in term T34, the relocation execution unit 23 executes relocation based on the long-term evaluation. Thus, the IO load of the specific allocation unit area increases in term T34. In term T35 included in term T34, the short-term tier control unit 11 executes short-term evaluation. However, the short-term tier control unit 11 checks that the specific allocation unit area is a target for the relocation based on the long-term evaluation from the relocation target information 242, and excludes, as illustrated in data 203, the specific allocation unit area from the target for the short-term evaluation. Therefore, the specific allocation unit area is not subjected to the short-term evaluation by the short-term tier control unit 11.

Thereafter, in term T36, the relocation execution unit 23 deletes the information of the specific allocation unit area from the relocation target information 242. Thus, as illustrated in data 204, the information of the specific allocation unit area is no longer included in the relocation target information 242. In other words, the short-term tier control unit 11 performs short-term evaluation including the specific allocation unit area in the target in term T36 and thereafter.

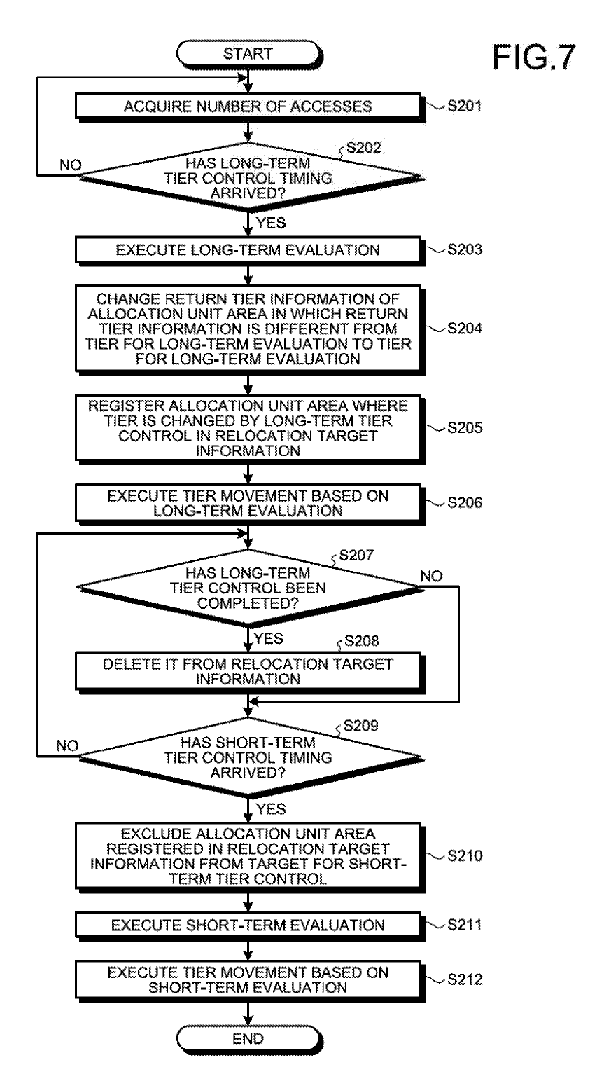

The flow of the automatic hierarchical control by the operation management server 1 according to the present embodiment will be explained next with reference to FIG. 7. FIG. 7 is a flowchart of the automatic hierarchical control by the operation management server according to the second embodiment. The allocation unit area as a target of relocation is set as “target area” herein. A case in which the state of the storage system is a state in which the long-term tier control timing arrives before the short-term tier control timing will be explained herein.

The short-term tier control unit 11 and the long-term tier control unit 12 acquire the number of accesses to the target area from the reading control unit 21 (Step S201).

The long-term tier control unit 12 determines whether a long-term tier control timing has arrived (Step S202). When a long-term tier control timing has not arrived (No at Step S202), the long-term tier control unit 12 returns to Step S201.

On the other hand, when a long-term tier control timing has arrived (Yes at Step S202), the long-term tier control unit 12 executes the long-term evaluation (Step S203). The long-term tier control unit 12 notifies the relocation execution unit 23 of relocation based on the long-term evaluation.

Subsequently, the relocation execution unit 23 changes the return tier information 241 for the allocation unit area in which the return tier information 241 is different from the tier of the long-term evaluation to the tier of the long-term evaluation (Step S204).

The relocation execution unit 23 then registers the allocation unit area where the tier is changed by the long-term tier control in the relocation target information 242 (Step S205).

Subsequently, the relocation execution unit 23 executes tier movement based on the long-term evaluation (Step S206).

The relocation execution unit 23 determines whether the long-term tier control has been completed (Step S207). When the long-term tier control has not been completed (No at Step S207), the process of automatic hierarchical control proceeds to Step S209.

On the other hand, when the long-term tier control has been completed (Yes at Step S207), the relocation execution unit 23 deletes the allocation unit area registered as an allocation unit area where the tier is changed by the long-term tier control from the relocation target information 242 (Step S208).

The short-term tier control unit 11 determines whether a short-term tier control timing has arrived (Step S209). When a short-term tier control timing has not arrived (No at Step S209), the process of automatic hierarchical control returns to Step S207.

On the other hand, when a short-term tier control timing has arrived (Yes at Step S209), the short-term tier control unit 11 excludes the allocation unit area registered in the relocation target information 242 from the target for the short-term tier control (Step S210).

The short-term tier control unit 11 executes short-term evaluation (Step S211).

Thereafter, the short-term tier control unit 11 performs tier movement based on the short-term evaluation (Step S212).

In the above description, the allocation unit area under execution of relocation based on the long-term evaluation is excluded from the target for the short-term evaluation. However, in addition to this, the relocation execution unit 23 may perform short-term evaluation on all the allocation unit areas and exclude the allocation unit area under execution of relocation based on the long-term evaluation from the target for tier movement.

Furthermore, it may be configured that the relocation execution unit 23 excludes the allocation unit area under execution of relocation based on the long-term evaluation from the target and performs the short-term evaluation to be relocated and thereafter executes the short-term tier control to the allocation unit area excluded from the target for the short-term evaluation immediately after the relocation based on the long-term evaluation.

As explained above, the storage system according to the present embodiment executes the short-term tier control except for the allocation unit area under execution of relocation based on the long-term evaluation. This makes it possible to suppress relocation based on an increase in the IO load due to execution of relocation based on the long-term evaluation.

### Third Embodiment

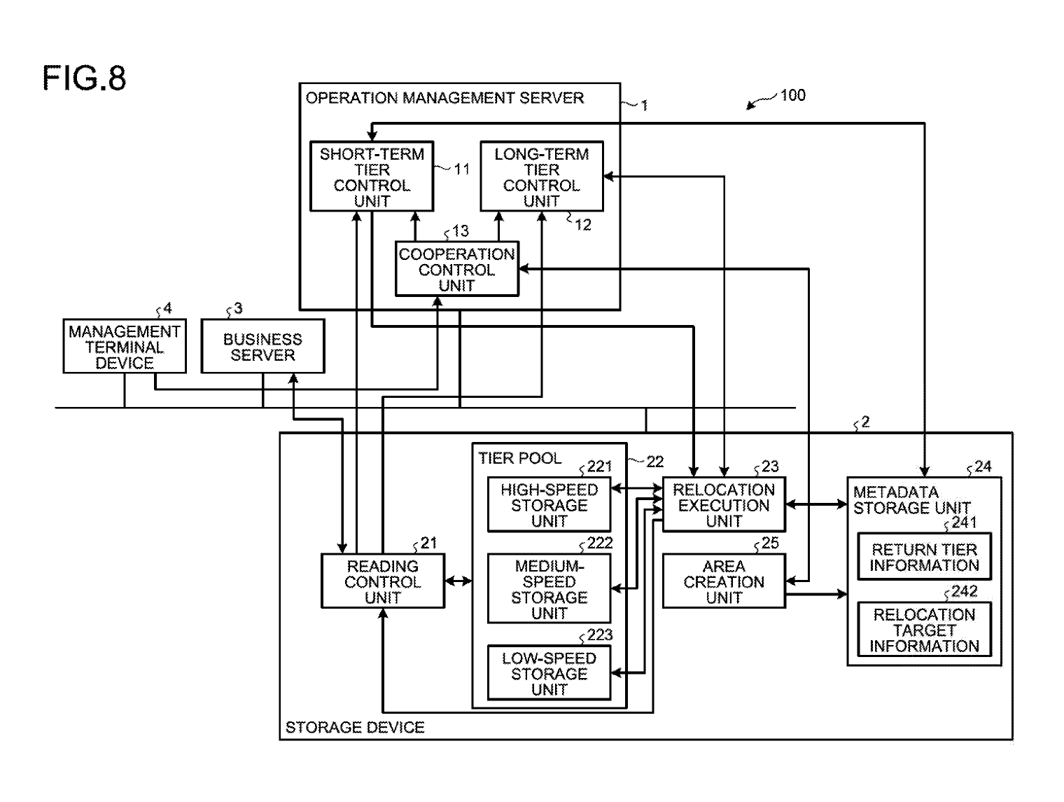

FIG. 8 is a block diagram of a storage system according to a third embodiment. A storage system 100 according to the present embodiment is different from the first and the second embodiments in that the metadata storage unit 24 is created in a dedicated area. How to create the metadata storage unit 24 in the dedicated area will be mainly explained below. Hereinafter, explanation of the operations of the units the same as these of the first and the second embodiments is omitted.

The operation management server 1 according to the present embodiment includes a cooperation control unit 13 in addition to the short-term tier control unit 11 and the long-term tier control unit 12.

The cooperation control unit 13 receives an instruction to execute the automatic hierarchical control from the management terminal device 4. The cooperation control unit 13 then transmits an instruction to secure metadata storage area to an area creation unit 25 of the storage device 2. Thereafter, the cooperation control unit 13 receives a response indicating that the metadata storage area is secured from the area creation unit 25. At this time, the cooperation control unit 13 also receives information for the metadata storage area from the area creation unit 25.

The cooperation control unit 13 notifies the short-term tier control unit 11 and the long-term tier control unit 12 of the start of the automatic hierarchical control. Furthermore, the cooperation control unit 13 notifies the short-term tier control unit 11 and the long-term tier control unit 12 of the information for the metadata storage area.

The storage device 2 includes the area creation unit 25. The area creation unit 25 receives the instruction to secure the metadata storage area from the cooperation control unit 13. The area creation unit 25 then secures a dedicated area, where metadata is stored, in a cache or the like. The secured dedicated area corresponds to the metadata storage unit 24. The area creation unit 25 transmits a response indicating that the metadata storage area is secured along with the information for the metadata storage area to the cooperation control unit 13 of the operation management server 1.

The relocation execution unit 23 registers the return tier information 241 and the relocation target information 242 in the metadata storage unit 24 which is the metadata storage area secured by the area creation unit 25.

The short-term tier control unit 11 and the long-term tier control unit 12 acquire the information for the metadata storage area along with an instruction to start the automatic hierarchical control from the cooperation control unit 13. Then, the short-term tier control unit 11 and the long-term tier control unit 12 exclude the metadata storage area from the targets for the short-term evaluation and the long-term evaluation. The short-term tier control unit 11 and the long-term tier control unit 12 execute the short-term evaluation and the long-term evaluation explained in the first embodiment or the second embodiment.

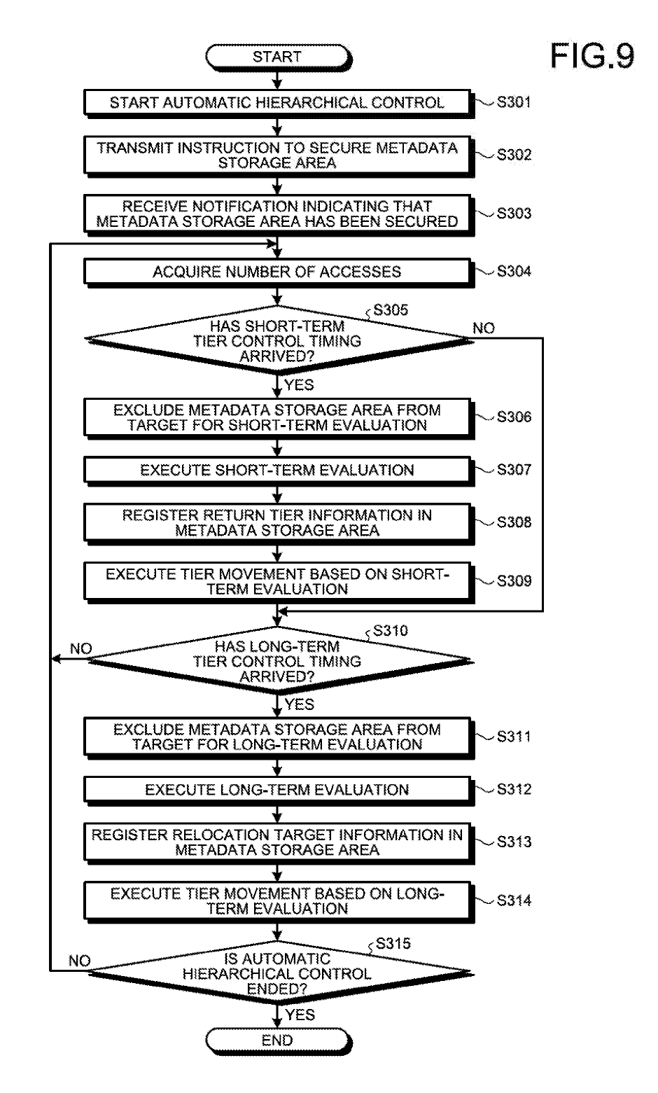

The flow of the automatic hierarchical control by the operation management server 1 according to the present embodiment will be explained next with reference to FIG. 9. FIG. 9 is a flowchart of the automatic hierarchical control by the operation management server according to the third embodiment. Herein below, the allocation unit area as a target of relocation is called “target area”.

The cooperation control unit 13 receives the instruction to start the automatic hierarchical control from the management terminal device 4. The cooperation control unit 13 then starts the automatic hierarchical control (Step S301).

The cooperation control unit 13 transmits an instruction to secure the metadata storage area to the area creation unit 25 (Step S302). The area creation unit 25 receives the instruction to secure the metadata storage area from the cooperation control unit 13.

The area creation unit 25 secures the metadata storage area in a cache or the like. The area creation unit 25 then transmits a notification indicating that the metadata storage area has been secured to the cooperation control unit 13. The cooperation control unit 13 receives the notification indicating that the metadata storage area has been secured along with the information for the metadata storage area from the area creation unit 25 (Step S303). The cooperation control unit 13 then notifies the short-term tier control unit 11 and the long-term tier control unit 12 of the start of the automatic hierarchical control. Moreover, the cooperation control unit 13 notifies the short-term tier control unit 11 and the long-term tier control unit 12 of the information for the metadata storage area.

The short-term tier control unit 11 and the long-term tier control unit 12 acquire the number of accesses for each allocation unit area from the reading control unit (Step S304).

Subsequently, the short-term tier control unit 11 determines whether a short-term tier control timing has arrived (Step S305). When a short-term tier control timing has not arrived (No at Step S305), the short-term tier control unit 11 and the long-term tier control unit 12 proceed to Step S310.

On the other hand, when a short-term tier control timing has arrived (Yes at Step S305), the short-term tier control unit 11 excludes the metadata storage area from the target for the short-term evaluation (Step S306).

The short-term tier control unit 11 then executes the short-term evaluation (Step S307). Moreover, the short-term tier control unit 11 registers the return tier information 241 in the metadata storage unit 24 which is the metadata storage area (Step S308). The short-term tier control unit 11 transmits an instruction of relocation based on the short-term evaluation to the relocation execution unit 23. The relocation execution unit 23 executes tier movement based on the short-term evaluation (Step S309).

The long-term tier control unit 12 determines whether a long-term tier control timing has arrived (Step S310). When a long-term tier control timing has not arrived (No at Step S310), the short-term tier control unit 11 and the long-term tier control unit 12 return to Step S304.

On the other hand, when a long-term tier control timing has arrived (Yes at Step S310), the long-term tier control unit 12 excludes the metadata storage area from the target for the long-term evaluation (Step S311).

The long-term tier control unit 12 then executes the long-term evaluation (Step S312). Moreover, the long-term tier control unit 12 registers the relocation target information 242 in the metadata storage unit 24 which is the metadata storage area (Step S313). The long-term tier control unit 12 transmits an instruction of relocation based on the long-term evaluation to the relocation execution unit 23. The relocation execution unit 23 executes tier movement based on the long-term evaluation (Step S314).

The cooperation control unit 13 determines whether the automatic hierarchical control is ended according to whether an instruction to end the automatic hierarchical control has been received from the management terminal device 4 (Step S315). When the automatic hierarchical control is continued (No at Step S315), the short-term tier control unit 11 and the long-term tier control unit 12 return to Step S304. On the other hand, when the automatic hierarchical control is ended (Yes at Step S315), the cooperation control unit 13 transmits the response to the management terminal device 4, and the operation management server 1 ends the process of automatic hierarchical control.

As explained above, the storage system according to the present embodiment secures the dedicated area as the metadata storage area, and excludes the metadata storage area from the targets for the short-term evaluation and the long-term evaluation. This makes it possible to prevent execution of relocation by the short-term evaluation and the long-term evaluation based on an increase in the load due to writing and reading of metadata, thus executing appropriate short-term evaluation and long-term evaluation.

Hardware Configuration

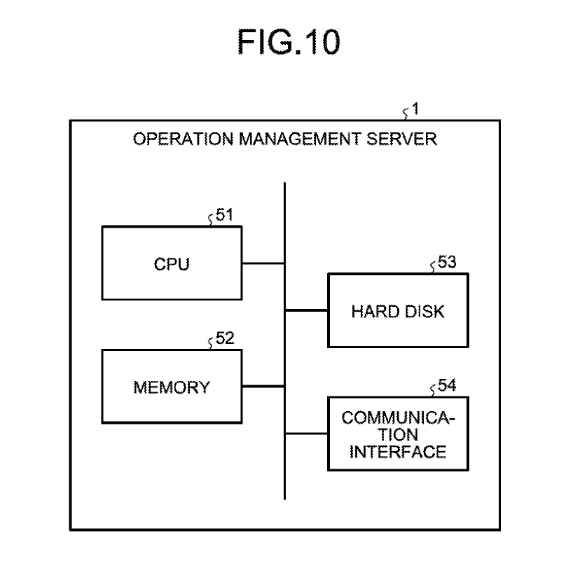

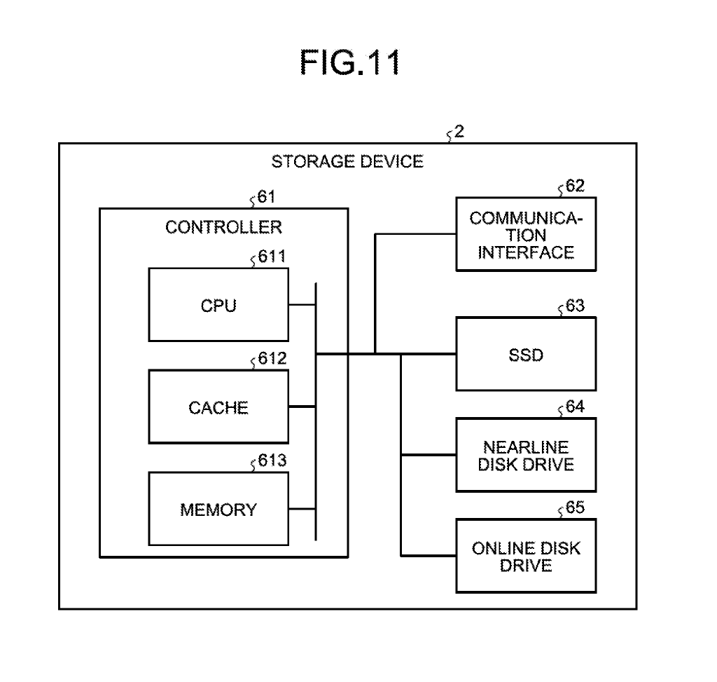

Hardware configurations of the operation management server 1 and the storage device 2 will be explained next with reference to FIG. 10 and FIG. 11. FIG. 10 is a hardware configuration diagram of the operation management server. FIG. 11 is a hardware configuration diagram of the storage device.

The operation management server 1 includes, as illustrated in FIG. 10, a central processing unit (CPU) 51, a memory 52, a hard disk 53, and a communication interface 54. The CPU 51 is connected to the memory 52, the hard disk 53, and the communication interface 54 through a bus.

The communication interface 54 is an interface for communicating with the storage device 2, the business server 3, and the management terminal device 4.

The hard disk 53 stores various programs including programs for implementing the functions of the short-term tier control unit 11, the long-term tier control unit 12, and the cooperation control unit 13 illustrated in, for example, FIG. 1, FIG. 5, and FIG. 8.

The CPU 51 reads the programs from the hard disk 53 to be loaded into the memory 52 and executes them, to thereby implement the functions of the short-term tier control unit 11, the long-term tier control unit 12, and the cooperation control unit 13 illustrated in FIG. 1, FIG. 5, and FIG. 8.

The storage device 2 includes, as illustrated in FIG. 11, a controller 61, a communication interface 62, an SSD 63, a nearline disk drive 64, and an online disk drive 65. The controller 61 includes a CPU 611, a cache 612, and a memory 613. The CPU 611 is connected to the cache 612 and the memory 613 through a bus. The CPU 611 is also connected to the communication interface 62, the SSD 63, the nearline disk drive 64, and the online disk drive 65 through a bus.

The communication interface 62 is an interface for communicating with the operation management server 1, the business server 3, and the management terminal device 4.

The SSD 63 implements the function of the high-speed storage unit 221 illustrated in, for example, FIG. 1, FIG. 5, and FIG. 8. The nearline disk drive 64 implements the function of the medium-speed storage unit 222 illustrated in, for example, FIG. 1, FIG. 5, and FIG. 8. The online disk drive 65 implements the function of the low-speed storage unit 223 illustrated in, for example, FIG. 1, FIG. 5, and FIG. 8. The cache 612 implements the function of the metadata storage unit 24 illustrated in, for example, FIG. 1, FIG. 5, and FIG. 8.

The memory 613 stores various programs including programs for implementing the functions of the reading control unit 21, the relocation execution unit 23, and the area creation unit 25 illustrated in FIG. 1, FIG. 5, and FIG. 8.

The CPU 611 reads the programs from the memory 613 to be loaded and executes them, to thereby implement the functions of the reading control unit 21, the relocation execution unit 23, and the area creation unit 25 illustrated in FIG. 1, FIG. 5, and FIG. 8.

The programs for implementing the functions of the short-term tier control unit 11, the long-term tier control unit 12, and the cooperation control unit 13 illustrated in FIG. 1, FIG. 5, and FIG. 8 are not always stored in the hard disk 53 from the beginning as explained above. For example, the programs are stored in a flexible desk, inserted into the operation management server 1, so-called “potable physical medium” such as a compact disk (CD), a digital versatile disk (DVD), a magneto-optical disk, and integrated circuit (IC) card. It may be configured that the operation management server 1 acquires the programs from the potable physical medium to execute them. It may also be configured that the programs are stored in other computer or a server device etc. connected to the operation management server 1 via a public line, the Internet, a local area network (LAN), and a wide area network (WAN), or the like, and that the operation management server 1 acquires the programs from these devices and executes them. The same goes for the reading control unit 21, the relocation execution unit 23, and the area creation unit 25 according to the storage device 2.

According to one aspect of the storage control device, the storage system, and the storage device control program disclosed in the present application, it is possible to improve the performance of the storage.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage control device comprising:
a processor configured to:
cause a storage device to execute first relocation, based on an access frequency to each of a plurality of storages with different performances provided in the storage device during a first period, of data stored in each of the storages to each of the storages and to return the data from the first relocation to an original location state;
determine a second relocation state of the data to each of the storages based on the access frequency to each of the storages during a second period that is longer than the first period;
cause the storage device to execute second relocation, based on the second relocation state, of data on which the first relocation is not performed; and
change the original location state of the data on which the first relocation is performed to the second relocation state.

2. The storage control device according to claim 1, wherein
the processor is configured to
causes, when the first relocation is to be performed, the storage device to store a location state of the data before the first relocation as the original location state, and relocates the data to the original location state stored in the storage device when the data is to be returned to the original location state, and
changes the original location state stored in the storage device to the second relocation state.

3. The storage control device according to claim 1, wherein
the processor is configured to
causes the storage device to store identification information of data targeted for execution of the second relocation, and deletes the identification information when the second relocation is ended, and
excludes the data corresponding to the identification information stored in the storage device from a target for the first relocation.

4. The storage control device according to claim 3, wherein the processor is configured to exclude the data in the original location state stored in the storage device, or the original location state and the data of the identification information from targets for the first relocation and the second relocation.

5. A storage system comprising a storage device and a storage control device, wherein
the storage device includes:
a plurality of storages with different performances, a relocation execution unit that performs relocation of data stored in each of the storages to each of the storages, and
a storage unit that receives an instruction from the storage control device to store an original location state, and
the storage control device includes:
a processor configured to:
cause the relocation execution unit to execute first relocation, based on an access frequency to each of the storages during a first period, of data stored in each of the storages to each of the storages and to return the data from the first relocation to the original location state;
determine a second relocation state of the data to each of the storages based on the access frequency to each of the storages during a second period that is longer than the first period;
cause the relocation execution unit to execute second relocation, based on the second relocation state, of data on which the first relocation is not performed; and
changes the original location state, stored in the storage unit, of the data on which the first relocation is performed to the second relocation state.

6. A non-transitory computer-readable recording medium having stored therein a program that causes a computer to execute a process comprising:
executing first relocation, based on an access frequency to each of a plurality of disks with different performances provided in a storage device during a first period, of data stored in each of the disks to each of the disks;
determining a second relocation state of the data to each of the disks based on the access frequency to each of the disks during a second period that is longer than the first period;
causing the storage device to execute a second relocation, based on the second relocation state, of data on which the first relocation is not performed, and changing an original location state of the data on which the first relocation is performed to the second relocation state; and
executing a return from the first relocation to the original location state based on the access frequency to each of the disks.
